(19) United States
(12) Patent Application Publication
(10) Pub. No.: US 2020/0114459 A1
(43) Pub. Date: Apr. 16, 2020

(54) QUALITY WELDING OF SIMILAR AND DISSIMILAR METAL WELDS WITH SPACE BETWEEN WORKPIECES

(71) Applicants: GM GLOBAL TECHNOLOGY OPERATIONS LLC, Detroit, MI (US); SHANGHAI JIAO TONG UNIVERSITY, Shanghai (CN)

(72) Inventors: Amberlee S. Haselhuhn, Troy, MI (US); David R. Sigler, SHELBY TOWNSHIP (US); Can Chen, Shanghai (CN)

(21) Appl. No.: 16/160,327

(22) Filed: Oct. 15, 2018

(51) Int. Cl. B23K 11/20; B23K 11/11; B23K 11/30; B23K 11/36

(52) U.S. Cl. CPC B23K 11/20; B23K 11/115; B23K 2101/006; B23K 11/36; B23K 11/3009

(57) ABSTRACT

A method of resistance spot welding and a spot-welded workpiece assembly are provided. First and second metallic workpieces are provided, each having faying surfaces including interface portions. The workpieces are disposed with the interface portions of their faying interfaces spaced apart from each other by a predetermined spacing distance. A set of opposed welding electrodes including a first electrode and a second electrode are provided, the first electrode being disposed on a side of the first workpiece, and the second electrode being disposed on a side of the second workpiece. Pressure is applied to the workpieces via the weld faces of the electrodes, and the workpieces are heated via the electrodes to form a spot weld joint between the interfaces of the faying surfaces. The faying surfaces may be spaced apart with shim material, a raised or folded-over portion of a workpiece, and/or a filler material having spacing particles.

### TECHNICAL FIELD

The technical field of this disclosure relates generally to resistance spot welding and, more particularly, to a methodology of resistance spot welding workpiece stack-ups that involves a technique of spacing apart the workpieces.

### INTRODUCTION

Resistance spot welding is a well-known joining technique that relies on resistance to the flow of an electrical current through overlapping metal workpieces and across their faying interface(s) to generate the heat needed for welding. To carry out such a welding process, a set of opposed spot welding electrodes is clamped at aligned spots on opposite sides of the workpiece stack-up, which typically includes two or three metal workpieces arranged in a lapped configuration. Electrical current is then passed through the metal workpieces from one welding electrode to the other. Resistance to the flow of this electrical current generates heat within the metal workpieces and at their faying interface(s). When the workpiece stack-up includes similar metal workpieces, such as two or more overlapping steel workpieces or two or more overlapping aluminum workpieces, the generated heat creates a molten weld pool that grows to consume the faying interface(s) and thus extends through all or part of each of the stacked metal workpieces. In that regard, each of the similarly-composed metal workpieces contributes material to the comingled molten weld pool. Upon termination of the passage of electrical current through the workpiece stack-up, the molten weld pool solidifies into a weld nugget that fusion welds the adjacent metal workpieces together.

The resistance spot welding process proceeds somewhat differently when the workpiece stack-up includes dissimilar metal workpieces. Most notably, when the workpiece stack-up includes an aluminum workpiece and a steel workpiece that overlap and confront to establish a faying interface, as well as possibly one or more flanking aluminum and/or one or more flanking steel workpieces (e.g., aluminum-aluminum-steel, aluminum-steel-steel, aluminum-aluminum-aluminum-steel, aluminum-steel-steel-steel), the heat generated within the bulk workpiece material and at the faying interface of the aluminum and steel workpiece creates a molten weld pool within the aluminum workpiece. The faying surface of the steel workpiece remains solid and intact and, consequently, the steel workpiece does not melt and comingle with the molten weld pool because of its much higher melting point, although elements from the steel workpiece, such as iron, may diffuse into the molten weld pool. This molten weld pool wets the confronting faying surface of the steel workpiece and, upon cessation of the current flow, solidifies into a weld joint that weld bonds or brazes the two dissimilar workpieces together.

Resistance spot welding is one of a handful of joining processes that can be used during the manufacture of multi-component assemblies. The automotive industry, for example, currently secures various vehicle body members (e.g., body sides, cross-members, pillars, floor panels, roof panels, engine compartment members, trunk compartment members, etc.) into an integrated multi-component body structure, often referred to as a body-in-white, that supports the subsequent installation of various vehicle closure members (e.g., doors, hoods, trunk lids, lift gates, etc.). In an effort to assimilate lighter weight materials into a vehicle body structure, there has been interest in strategically incorporating both aluminum workpieces and steel workpieces into the body-in-white. A typical process for structurally securing the body-in-white involves, first, positioning and supporting the vehicle body members relative to one another precisely as intended in the final body-in-white structure. The vehicle body members in need of joining are laid up or fitted together such that flanges or other bonding regions of the body members overlap to provide a workpiece stack-up of two or more overlapping workpieces. When the fixture of vehicle body members includes workpiece stack-ups with different combinations of metal workpieces, the workpiece stack-ups are also joined with self-piercing rivets, although recent technological advances have made resistance spot welding a viable and dependable option. The formation of spot welds and the installation of self-piercing rivets are carried out by weld and rivet guns according to a programmed and coordinated sequence until all of the vehicle body members are secured in place. The overall assembly process is repeated over and over on a production line with the goal of steadily producing body-in-white structures at an acceptable output rate with minimum unnecessary downtime.

The initiative to develop a resistance spot welding approach that can successfully spot weld the diverse combinations of metal workpieces that may be found in a body-in-white has recently gained traction, as such an approach could significantly reduce or altogether eliminate the need to use costly, weight-adding, and laborious-to-install rivets (and their associated rivet guns) during the construction of the body-in-white. But spot welding the various combinations of metal workpieces that may be presented in a workpiece stack-up poses certain challenges. First, the melting ranges for aluminum alloys and steel materials are vastly different, i.e., approximately 900° C. apart, which results in aluminum melting while the steel remains solid and can create solidification porosity along the faying interface that weakens the joint. Second, aluminum and steel form a series of brittle intermetallic compounds at the faying interface that, if excessively thick, can weaken the joint. Third, the oxide coating on aluminum interferes with current flow and can become incorporated within the growing aluminum weld nugget creating a series of microcracks along the faying interface that weakens the joint. These challenges make producing strong joints difficult. In some cases, the weld joints even break apart and become discrepant, and the workpieces are scrapped.

### SUMMARY

A method of resistance spot welding is provided that includes creating a predetermined spacing or gap between workpieces prior to applying the electrode pressure and current to complete the weld joint. Providing a space between the workpieces causes an aluminum workpiece to wrap around the weld face of the electrode, and as a result, extend away from the adjacent workpiece. As such, the notch angle created during welding is large, leading to a robust weld joint able to handle high loads. Furthermore, the gap or spacing between workpieces results in a stable weld size, and under non-ideal conditions, such as sheet angles, may be corrected for or deemed irrelevant when a predetermined spacing is induced between the workpieces.

In one form, which may be combined with or separate from the other forms disclosed herein, a method of resistance spot welding workpiece stack-ups is provided that includes providing a metallic first workpiece having a first workpiece faying surface including an interface portion and providing a second metallic workpiece having a second workpiece faying surface and an interface portion. The method also includes disposing the first and second metallic workpieces with the interface portions of the first and second workpiece faying surfaces spaced apart a predetermined spacing distance from each other. The predetermined spacing distance is in the range of 0.25 to 2.5 millimeters. The method includes providing a set of opposed welding electrodes including a first electrode and a second electrode, the first electrode being disposed on a side of the first workpiece, and the second electrode being disposed on a side of the second workpiece. Further, the method includes applying pressure to the workpieces via the weld faces of the set of electrodes and heating the workpieces via the electrodes to form a spot weld joint between the interface portions of the first and second workpiece faying surfaces.

In another form, which may be combined with or separate from the other forms provided herein, a spot-welded workpiece assembly is provided that includes a metallic first workpiece and a metallic second workpiece spot welded to the first workpiece by a spot weld joint. The first and second workpieces have a notch root angle therebetween at an edge of the spot weld joint, the notch root angle being at least 25 degrees. A gap-inducing element is disposed between the first and second workpieces and configured to space apart interface portions of the faying surfaces of the first and second workpieces by a predetermined distance prior to spot welding the first and second workpieces together.

Additional features may be provided, including but not limited to the following: the predetermined spacing distance being in the range of 0.25 to 2.5 millimeters; wherein the second workpiece is formed of a steel alloy and the first workpiece is formed of aluminum or an aluminum alloy; wherein each of the first and second workpieces is formed of aluminum or an aluminum alloy; the interface portion of the first workpiece faying surface and the interface portion of the second workpiece faying surface being spaced apart from each other via an air gap; disposing shim material between the first and second workpieces to space the first and second workpieces apart from one another; providing a cutout in the shim material to provide the air gap between the first and second faying surfaces; wherein the cutout is provided as being larger than an electrode weld face of the set of the electrodes; providing the shim material as a polymeric material, at least one wire, at least one rod, and/or a plurality of beads; providing the second workpiece having a raised portion contacting the first workpiece and providing the second workpiece having a valley bottom portion disposed at the interface portions of the second workpiece faying surface; the valley bottom portion being disposed away from the first workpiece so that the air gap is disposed between the valley portion bottom and the first workpiece; providing the second workpiece as having a folded-over portion contacting the first workpiece and a gap bottom portion disposed away from the first workpiece so that the air gap is disposed between the gap bottom portion and the first workpiece; disposing a filler material between the first and second workpieces to create the predetermined spacing distance therebetween; the filler material comprising a plurality of particles disposed within the filler material; wherein each particle is adapted to space apart the interface portions of the first and second faying surfaces; providing the filler material as being an adhesive material and/or a sealing material; providing each particle having a height that is about equal to the predetermined spacing distance; providing the first workpiece and the first electrode with a sheet angle therebetween; the sheet angle being at least three degrees; wherein the step of heating the workpieces is accomplished by passing electrical current between the workpieces via the electrodes; resulting in the spot weld joint having a notch root angle between the first and second workpieces, the notch root angle being at least 25 degrees; wherein the gap-inducing element is a shim having portions forming a cutout therethrough, the spot weld joint extending through the cutout; the gap-inducing element including at least one of: a raised portion formed in one of the first and second workpieces, a folded-over portion of one of the first and second workpieces, and a filler material having a plurality of gap-inducing particles disposed therein; and the predetermined spacing distance being in the range of 0.8 to 1.5 millimeters.

The above and other advantages and features will become apparent to those skilled in the art from the following detailed description and accompanying drawings.

### BRIEF DESCRIPTION OF THE DRAWINGS

The drawings described herein are for illustration purposes only and are not intended to limit the scope of the present disclosure in any way.

FIG. 1 is a perspective view illustrating a multi-component integrated assembly in the form of an automobile body-in-white that may be secured together from a fixture of individual vehicle body members by a plurality spot welds, in accordance with the principles of the present disclosure;

FIG. 2A is an end view of a workpiece stack-up that includes at least a first metal workpiece, a second metal workpiece, and a first variation of a gap-inducing element in the form of shim material disposed therebetween, for spot welding as part of the overall construction of the multi-component integrated assembly depicted in FIG. 1, which is also applicable to a variety of other assemblies, according to the principles of the present disclosure;

FIG. 2B is a plan view of the second metal workpiece and the gap-inducing element of FIG. 2A, with the first metal workpiece removed to show details of the gap-inducing element, in accordance with the principles of the present disclosure;

FIG. 3 is a schematic side view illustrating a partial schematic view of a weld gun that carries a set of opposed welding electrodes and is configured to spot weld workpiece stack-ups together, such as the workpiece stack-up illustrated in FIGS. 2A-2B, in accordance with the principles of the present disclosure;

FIG. 4 is a cross-sectional view of a spot-welded workpiece stack-up, such as that initially shown in FIGS. 2A-2B, showing the formation of an aluminum-to-steel spot weld using welding electrodes, for example, as illustrated in FIG. 3, and utilizing the method of the present disclosure, according to the principles of the present disclosure;

FIG. 5A is an end view of a workpiece stack-up that includes at least a first metal workpiece, a second metal workpiece, and another variation of gap-inducing elements in the form of a raised portion and a folded-over portion disposed between the workpieces, which may be used for spot welding as part of the overall construction of the multi-component integrated assembly depicted in FIG. 1, and which is also applicable to a variety of other assemblies, according to the principles of the present disclosure;

FIG. 5B is a plan view of the second metal workpiece and the gap-inducing elements of FIG. 5A, with the first metal workpiece removed to show details of the gap-inducing elements, in accordance with the principles of the present disclosure;

FIG. 6A is an end view of a workpiece stack-up that includes at least a first metal workpiece, a second metal workpiece, and yet another variation of gap-inducing elements in the form of rods disposed between the workpieces, which may be used for spot welding as part of the overall construction of the multi-component integrated assembly depicted in FIG. 1, and which is also applicable to a variety of other assemblies, according to the principles of the present disclosure;

FIG. 6B is a plan view of the second metal workpiece and the gap-inducing elements of FIG. 6A, with the first metal workpiece removed to show details of the gap-inducing element, in accordance with the principles of the present disclosure;

FIG. 7A is an end view of a workpiece stack-up that includes at least a first metal workpiece, a second metal workpiece, and still another variation a gap-inducing element in the form of particle-bearing adhesive disposed between the workpieces, which may be used for spot welding as part of the overall construction of the multi-component integrated assembly depicted in FIG. 1, and which is also applicable to a variety of other assemblies, according to the principles of the present disclosure;

FIG. 7B is a plan view of the second metal workpiece and the gap-inducing element of FIG. 7A, with the first metal workpiece removed to show details of the gap-inducing element, in accordance with the principles of the present disclosure; and

FIG. 8 is a block diagram illustrating a method of resistance spot welding workpiece stack-ups, in accordance with the principles of the present disclosure.

### DETAILED DESCRIPTION

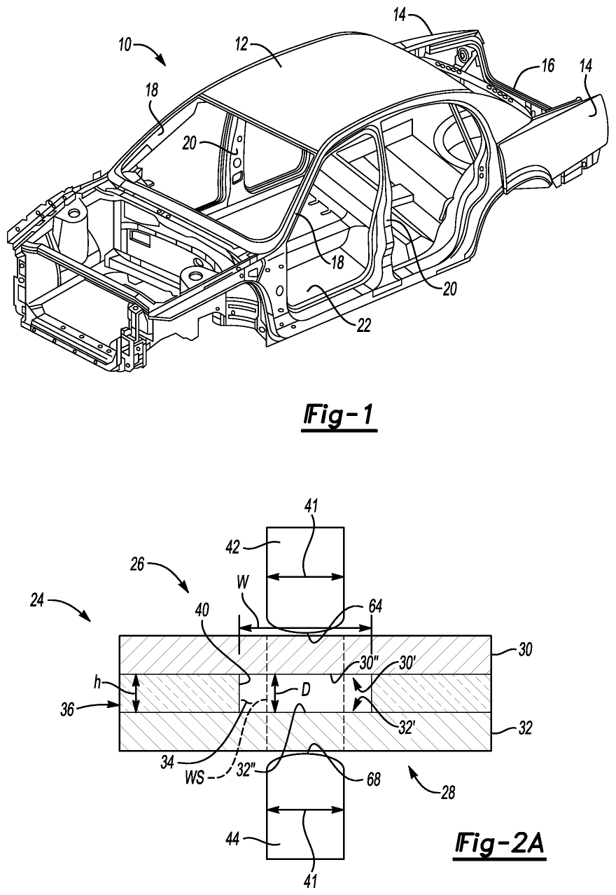

Referring now to FIG. 1, a multi-component integrated assembly 10 is illustrated in the form of a body-in-white during the manufacture of an automobile. The multi-component body-in-white assembly 10 includes a roof panel 12, rear quarter panels 14, a rear trunk wall 16, A pillars 18, B pillars 20, and floor members 22 and related underbody structure, among other vehicle body members. Certain of these vehicle body members may be formed of an aluminum workpiece, such as the roof and quarter panels 12, 14 and the trunk wall 16, and certain of the other vehicle body members may be formed of a steel workpiece, such as the A and B pillars 18, 20 and the floor members 22.

Prior to being secured together into the unitary, integrated body-in-white assembly 10, the various vehicle body members 12, 14, 16, 18, 20, 22 are positioned and supported relative to one another by a fixturing device or devices. In doing so, flanges or other bonding regions of the body members 12, 14, 16, 18, 20, 22 are arranged in lapped configurations with corresponding flanges or bonding regions of other body members to provide a multitude of workpiece stack-ups with two-side access where one or more resistance spot welds can be formed to secure the vehicle body members together that contribute to each particular stack-up. Some of the established workpieces stack-ups may include similar metal workpieces, i.e., all aluminum workpieces or all steel workpieces, while some of the stack-ups may include a combination of aluminum and steel workpieces. An intermediate organic material such as a weld-through adhesive or a sealer may optionally be included between the lapped workpieces in each stack-up if desired.

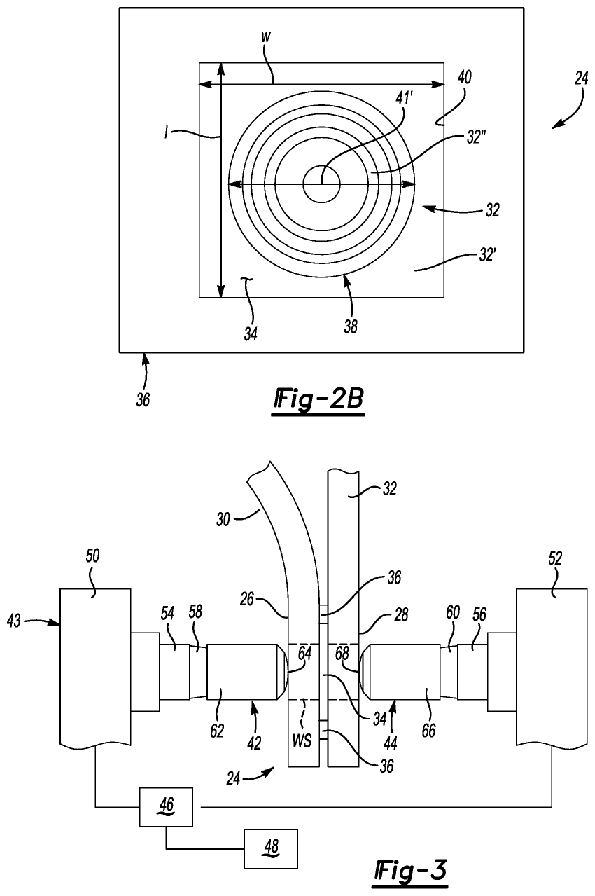

A workpiece stack-up 24 is shown in FIG. 2A which may be part of the overall construction of multi-component body-in-white assembly 10. The workpiece stack-up 24 has a first side 26 and a second side 28 and includes at least a first metal workpiece 30 and a second metal workpiece 32. The first metal workpiece 30 provides the first side 26 of the stack-up 24 and the second metal workpiece 32 provides the second side 28; however, it should be understood that additional flanking workpieces may be provided on the outer sides of the workpieces 30, 32 to form the outer sides 26, 28 of the stack-up 24. For example, in some implementations, the workpiece stack-up 24 includes only the first and second metal workpieces 30, 32 (a “2T” stack-up). In other implementations, an additional metal workpiece (not shown) may be positioned adjacent to one of the first and second metal workpieces 30, 32 and extend through the weld site WS (a “3T” stack-up or a “4T” stack-up). Further additional workpieces may be added in the stack-up, if desired, where aluminum sheets are stacked adjacent to each other and steel sheets are stacked adjacent to each other. Each of the first and second sides 26, 28 of the stack-up 24 is accessible to a spot welding electrode 42, 44 such that the workpiece stack-up 24 can be clamped between the pair of opposed spot welding electrodes 42, 44 at a weld site WS.

Referring back to FIG. 2A, the first workpiece 30 may be formed of unalloyed aluminum or an aluminum alloy, by way of example. The second workpiece 32 may be formed of steel, unalloyed aluminum, or an aluminum alloy, by way of example.

If alloyed, the aluminum alloy may include at least 85 wt % aluminum. The unalloyed aluminum or aluminum alloy workpiece 30 (and workpiece 32 in some variations) may be either coated or uncoated. Some notable aluminum alloys that may constitute the coated or uncoated aluminum substrate are an aluminum-magnesium alloy, an aluminum-silicon alloy, an aluminum-magnesium-silicon alloy, an aluminum-manganese alloy, and an aluminum-zinc alloy. If coated, the aluminum substrate may include a surface layer of a refractory oxide material (native and/or produced during manufacture when exposed to high-temperatures, e.g., mill scale) comprised of aluminum oxide compounds and possibly other oxide compounds such as, for example, those of magnesium oxide if the aluminum substrate contains magnesium. The aluminum substrate may also be coated with a layer of zinc, tin, or a metal oxide conversion coating comprised of oxides of titanium, zirconium, chromium, or silicon, such as described in U.S. Pat. No. 9,987,705, which is hereby incorporated by reference in its entirety. The surface layer may have a thickness ranging from 1 nm to 10 μm and may be present on each side of the aluminum substrate. The aluminum workpiece 30 (and optionally workpiece 32) may have a thickness that ranges from 0.3 mm to 6.0 mm, or more narrowly from 0.5 mm to 3.0 mm, at least at the weld site WS.

The aluminum workpiece 30 (and/or workpiece 32) may be provided in wrought or cast form. For example, the workpiece 30 (and/or workpiece 32) may be composed of a 3XXX, 4xxx, 5xxx, 6xxx, or 7xxx series wrought aluminum alloy sheet layer, extrusion, forging, or other worked article. Alternatively, the workpiece 30 (and/or workpiece 32) may be composed of a 4xx.x, 5xx.x, 6xx.x, or 7xx.x series aluminum alloy casting. Some more specific kinds of aluminum alloys that may be used include, but are not limited to, AA3003 aluminum-manganese alloy, AA5754 and AA5182 aluminum-magnesium alloy, AA6111 and AA6022 aluminum-magnesium-silicon alloy, AA7003 and AA7055 aluminum-zinc alloy, and Al-10Si—Mg aluminum die casting alloy. The aluminum workpiece 30 (and/or workpiece 32) may further be employed in a variety of tempers including annealed (O), strain hardened (H), and solution heat treated (T), if desired. When more than one aluminum or aluminum alloy workpiece 30 (and/or workpiece 32) is present in the workpiece stack-up 24, the workpieces may be the same or different in terms of their compositions, thicknesses, and/or form (e.g., wrought or cast).

The workpiece 32 alternatively may be formed of a steel substrate of any of a wide variety of strengths and grades that is either coated or uncoated. The steel substrate may be hot-rolled or cold-rolled and may be composed of steel such as mild steel, interstitial-free steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the steel workpiece includes press-hardened steel (PHS). If coated, the steel substrate preferably includes a surface layer of zinc (e.g., hot-dip galvanized or electrogalvanized), a zinc-iron alloy (e.g., galvannealed or electrodeposited), a zinc-nickel alloy, nickel, aluminum, an aluminum-magnesium alloy, an aluminum-zinc alloy, or an aluminum-silicon alloy, any of which may have a thickness of up to 50 μm and may be present on each side of the steel substrate. The steel workpiece 32 may have a thickness that ranges from 0.3 mm to 6.0 mm, or more narrowly from 0.6 mm to 2.5 mm, at least at the weld site WS.

When the workpiece stack-up 24 includes more than two workpieces, two of the adjacent metal workpieces may be aluminum workpieces and the other metal workpiece may be a steel workpiece, or two of the adjacent metal workpieces may be steel workpieces and the other metal workpiece may be an aluminum workpiece. When the workpiece stack-up 24 includes the four metal workpieces, two of the adjacent metal workpieces may be aluminum workpieces and the other two adjacent metal workpieces may be steel workpieces, three of the adjacent metal workpieces may be aluminum workpieces and the other metal workpiece may be a steel workpiece, or three of the adjacent metal workpieces may be steel workpieces and the other metal workpiece may be an aluminum workpiece. In the alternative, all of the workpieces may be aluminum with none being steel.

The first and second workpieces 30, 32 each having faying surfaces 30′, 32′ respectively that will be bonded together after a spot welding operation, as described in further detail below. Each faying surface 30′, 32′ has an interface 30″, 32″ portion at the weld site WS, wherein the interface portions 30″, 32″ of the faying surfaces 30′, 32′ are bonded together after the welding operation.

The first and second workpieces 30, 32 are disposed with the interface portions 30″, 32″ of the first and second workpiece faying surfaces 30′, 32′ spaced apart a predetermined spacing distance D from each other. In the example of FIG. 2A, the first and second workpieces 30, 32 are spaced apart the distance D via an air gap 34. The predetermined spacing distance D may be in the range of 0.25 to 2.5 millimeters, by way of example. In some variations, D may be in the range of 0.25 to 1.5 mm, 0.5 to 1.5 mm, 0.8 to 1.5 mm, or 0.75 to 1.25 mm. The predetermined spacing D need not be consistent through the entire volume of open space between the first and second faying surfaces 30′, 32′. Rather, the actual distance D between the first and second faying surfaces 30′, 32′ may vary throughout the volume of space within the air gap 34, so that the distance D may be, for example, 0.5 mm between the faying surfaces 30′, 32′ in one place and 0.6 mm between the faying surfaces 30′, 32′ in another place.

Referring to FIGS. 2A-2B, the interface portions 30″, 32″ of the workpiece faying surfaces 30′, 32′ are spaced apart from each other by a shim material 36. FIG. 2B is a plan view with the first workpiece 30 removed to show details of the shim material 36 and the second workpiece 32, with a peeled-away weld button produced 38 produced by the welding operation described in further detail below. In this case, the shim material 36 is a piece of Teflon material having a height h equal to the distance D of the spacing between the faying interfaces 30″, 32″.

The shim material 36 has a rectangle-shaped, square-shaped, circular, or other shape cutout 40 formed therethrough that forms the air gap 34 between the first and second faying surfaces 30′, 32′. The cutout 40 has a width w and length 1 that are each larger than the diameter 41 of the weld faces 64, 68 of the electrodes 42, 44 and the diameter 41′ of the weld button 38. In some cases, the width w and length 1 of the cutout 40 are larger than the peeled-away weld button 38 (representative of the weld nugget) and/or the electrode weld faces 64, 68 by at least 1 or 1.5 mm, in some cases 5 mm, on all sides of the electrode weld faces 64, 68 or peeled-away weld button 38. Thus, the gap 34 may have a 10-20 mm radius, where the weld button 38 is formed though the gap 34. As such, the interface portions 30″, 32″ that will ultimately become the weld are disposed entirely within the cutout 40, and the weld button 38 is formed through the cutout 40. The shim material 36 need not necessarily be Teflon, and could be alternatively formed of any other desired material, such as another polymeric material, aluminum, steel, noise dampening material, ceramic, glass, or any other desired material. The shim material 36 may be provided as a conductive or a non-conductive material. The shim material 36 may be formed of a sheet of material, as shown, or it may alternatively be formed of wires, rods, beads, or having any other desired form. The shim 36 may have a thickness equal to the thickness of the gap 34, such as the spaced apart distance D. The thickness of the shim 36 may be consistent along the length 1 and width w of the shim 36, or the thickness of the shim 36 may be varied along the width w and/or length 1, if desired.

Referring now to FIG. 3, a weld gun 43 may form spot welds in the various assembled workpiece stack-ups 24 of the body-in-white assembly 10 to secure their constituent metal workpieces together. The weld gun 43 carries a first welding electrode 42 and an opposed second welding electrode 44. As used herein, a “weld,” “welded,” or “welding” is used to refer to a resistance spot welding process of joining that involves heating adjacent workpieces by passing an electrical current to resistively heat adjacent workpieces until at least one of the workpieces melts at a faying interface to join the adjacent workpieces together. Similarly, the phrase “spot weld” is also used here as a generic term that encompasses the weld nugget structure that fusion welds together overlapping aluminum workpieces or overlapping steel workpieces as well as a weld joint structure that weld bonds or brazes together an aluminum workpiece and an adjacent overlapping steel workpiece at each weld site WS where spot welding is performed.

The first and second welding electrodes 42, 44 are mechanically and electrically coupled to the weld gun 43, which can support forming a rapid succession of spot welds. In some examples, the welding electrodes 42, 44 may be water-cooled. The weld gun 43, for example, may be a C-type gun or an X-type gun, or some other type. A floor mounted, pedestal weld gun may be used when parts are sufficiently small to be manipulated by a robot or by hand, otherwise the weld gun 43 may be mounted on a robot capable of moving it in and around the fixture of vehicle body members to gain access to the workpiece stack-ups 24.

Additionally, as illustrated schematically here, the weld gun 43 may be associated with a power supply 46 that delivers electrical current between the welding electrodes 42, 44 according to one or more programmed weld schedules administered by a weld controller 48. The weld gun 43 may also be fitted with coolant lines and associated control equipment in order to deliver a cooling fluid, such as water, to each of the welding electrodes 42, 44 during spot welding operations to help manage the temperature of the electrodes 42, 44.

The weld gun 43 includes a first gun arm 50 and a second gun arm 52. The first gun arm 50 is fitted with a shank 54 that secures and retains the first welding electrode 42 and the second gun arm 52 is fitted with a shank 56 that secures and retains the second welding electrode 44. The secured retention of the welding electrodes 42, 44 on their respective shanks 54, 56 can be accomplished by way of shank adapters 58, 60 that are located at axial free ends of the shanks 54, 56. In terms of their positioning relative to the workpiece stack-up 24, the first welding electrode 42 is positioned for contact with the first side 26 of the stack-up 24, and the second welding electrode 44 is positioned for contact with the second side 28 of the stack-up 24. The first and second weld gun arms 50, 52 are operable to converge or pinch the welding electrodes 42, 44 towards each other and to impose a clamping force on the workpiece stack-up 24 at the weld site WS once the electrodes 42, 44 are brought into contact with their respective workpiece stack-up sides 26, 28.

One or both of the first and second welding electrodes 42, 44 may be constructed as a multi-ringed domed (“MRD”) welding electrode, such as that illustrated in U.S. Pat. App. Pub. No. 2017/0304928, which is hereby incorporated by reference in its entirety, and is formed of an electrically conductive material such as, for example, a copper alloy. One specific example of a suitable copper alloy is a C15000 copper-zirconium alloy (CuZr) that contains 0.10 wt % to 0.20 wt % zirconium and the balance copper. Other copper materials may be employed including, for example, a C18200 copper-chromium alloy (CuCr) that includes 0.6 wt % to 1.2 wt % chromium and the balance copper; a C18150 copper-chromium-zirconium alloy (CuCrZr) that includes 0.5 wt % to 1.5 wt % chromium, 0.02 wt % to 0.20 wt % zirconium, and the balance copper; or a dispersion strengthened copper material such as copper with an aluminum oxide dispersion. Still further, other compositions that possess suitable mechanical and electrical/thermal conductivity properties may also be used including more resistive electrodes that are composed of a refractory metal (e.g., molybdenum or tungsten) or a refractory metal composite (e.g. tungsten-copper). In variations where one of the workpieces 30, 32, such as the second workpiece 32, is formed of steel, it may be preferable to provide the second electrode 44 as a ballnose electrode.

The first welding electrode 42 includes an electrode body 62 and a first weld face 64 and, likewise, the second welding electrode 44 includes an electrode body 66 and a second weld face 68. The weld faces 64, 68 of the first and second welding electrodes 42, 44 are the portions of the electrodes 42, 44 that are pressed against, and impressed into, the opposite sides 26, 28 of the workpiece stack-up 24 to communicate electrical current during each instance the weld gun 43 is operated to conduct spot welding. Thus, the first electrode 42 is disposed on the outer side 26 of the stack-up 24, and the second electrode 44 is disposed on the outer side 28 of the stack-up 24.

The weld gun 43 is operable to pass electrical current between the facially-aligned weld faces 64, 68 of the first and second welding electrodes 42, 44 and through the workpiece stack-up 24 at the weld site WS. The exchanged electrical current is preferably a DC (direct current) electrical current that is delivered by the power supply 46 which, as shown, electrically communicates with the first and second welding electrodes 42, 44. The power supply 46 is preferably a medium frequency direct current (MFDC) inverter power supply that includes a MFDC transformer. A MFDC transformer can be obtained commercially from a number of suppliers including Roman Manufacturing (Grand Rapids, Mich.), ARO Welding Technologies (Chesterfield Township, Mich.), and Bosch Rexroth (Charlotte, N.C.). The characteristics of the delivered electrical current are controlled by the weld controller 48. Specifically, the weld controller 48 allows a user to program a weld schedule that sets the waveform of the electrical current being exchanged between the welding electrodes 42, 44. The weld schedule allows for customized control of the current level at any given time and the duration of current flow at any given current level, among others, and further allows for such attributes of the electrical current to be responsive to changes in very small time increments down to fractions of a millisecond.

The weld gun 43 is used to form spot welds needed to structurally support the multi-component integrated body-in-white assembly 10. The weld faces 64, 68 are pressed against the outer sides 26, 28 of the stack-up, and pressure is applied. The workpieces 30, 32 are heated via the current passed by the electrodes 42, 44 to form a spot weld joint between the interface portions 30″, 32″ of the first workpiece faying surface 30′ and the second workpiece faying surface 32′.

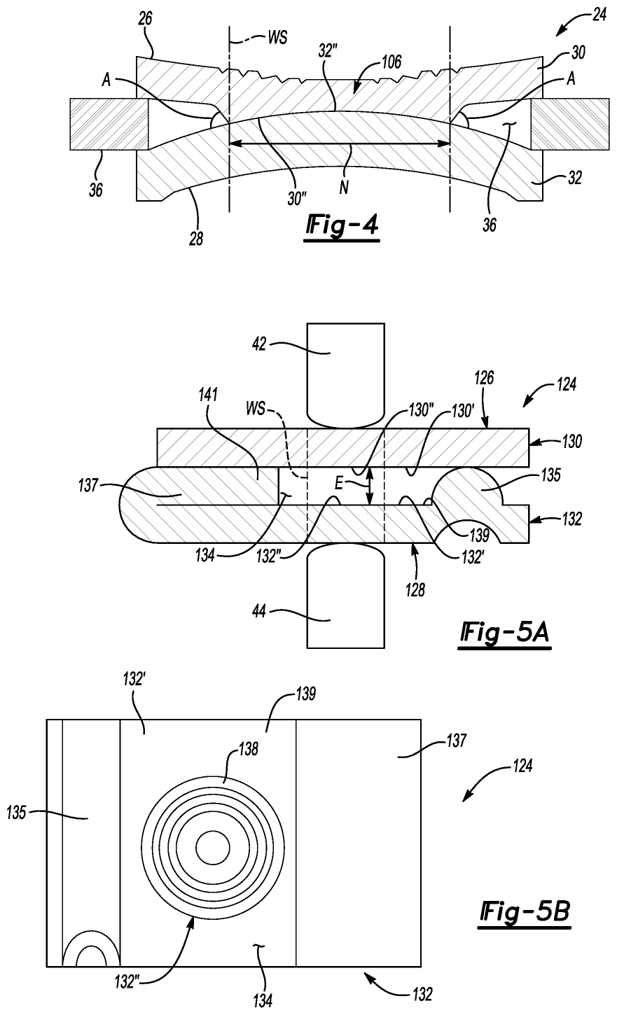

Referring now to FIG. 4, the workpiece stack-up 24 is spot welded to form an initial aluminum-steel spot weld 106 (or, in the alternative, an aluminum-aluminum spot weld). For aluminum-to-aluminum spot welds, the workpiece stack-up 24 would preferably have three or more sheets 30, 32.

The formation of the aluminum-to-steel spot weld 106 begins by pressing the weld face 64 of the first welding electrode 42 and the weld face 68 of the second welding electrode 44 against the first side 26 and the second side 28, respectively, of the workpiece stack-up 24 at the weld site WS under an imposed clamping force in a first relative position between the set of electrodes 42, 44 and the workpieces 30, 32. The force applied by the welding electrodes 42, 44 ranges from 400 lb to 2000 lb and preferably from 600 lb to 1300 lb, by way of example.

Once the electrodes 42, 44 are pressed in place, the electrodes 42, 44 are initially energized to pass an electrical current between the facially-opposed weld faces 64, 68 and through the workpiece stack-up 24. The passing of electrical current generates heat and creates a molten aluminum weld pool within the aluminum workpiece 30 that lies adjacent to and contacts the steel workpiece 32. The molten aluminum weld pool wets the adjacent steel workpiece, which does not contribute molten material to the weld pool, and penetrates into aluminum workpiece, typically to a distance of 10% to 100% of its thickness and preferably 20% to 80%, from the faying surfaces 30′, 32′ of the aluminum and steel workpieces 30, 32. Upon ceasing passage of the electrical current, the molten aluminum weld pool solidifies into the weld joint 106 that weld bonds or brazes the aluminum and steel workpieces 30, 32 together. The size of the weld, or weld nugget diameter N, may be in the range of 3 to 15 mm, or preferably 6 to 12 mm, by way of example.

The structure of the aluminum weld joint 106 formed within the workpiece stack-up(s) 24 at each weld site WS is essentially the same at the faying surfaces 30′, 32′ regardless of whether any additional metal workpieces are included in the stack-up 24. If, on the other hand, both workpieces 30, 32 are provided as aluminum workpieces in the workpiece stack-up 24, the weld pool would be formed in both workpieces 30, 32.

In all examples, the weld gun 43 can be configured so that each spot weld joint or attempted weld joint 106 in the body-in-white is formed according to its own unique weld schedule depending on the gauge, workpiece substrate composition, workpiece surface coating composition, stack-up thickness, etc. And while any suitable weld schedule may be employed to carry out formation of the aluminum-to-steel spot welds, a particularly preferred weld schedule is disclosed in U.S. Pat. App. Pub. No. 2017/0106466, the entire contents of which are incorporated herein by reference.

Providing a space D between the workpieces 30, 32 causes the aluminum workpiece 30 to wrap around the weld face 64 of the electrode 42, and as a result, extend away from the adjacent workpiece 32. More particularly, the gap 34 causes the electrode 42 to sheet 30 contact area to be increased, and the sheet 30 to sheet 32 contact area to be decreased. This has the combined effect of increasing current density at the faying surfaces 30′, 32′ and decreasing the size of the hydraulic zones. In addition, the gap or spacing 34 causes the notch root angle A between the workpieces 30, 32 to be increased as the sheet 30 wraps around the tip of the electrode 42, leading to a more robust weld joint 106 able to handle higher tensile shear or other loads. The notch root angle A is preferably at least 8 degrees, and in the illustrated example in FIG. 4, the notch root angle A is greater than 15, 25, 30, 34, or 45 degrees.

Referring now to FIGS. 5A-5B, another variation of the workpiece stack-up is illustrated and generally designated at 124. It should be understood that the workpiece stack-up 124 may be used in place of the workpiece stack-up 24, for example, on the body-in-white 10. Unless described as being different, the workpiece stack-up 124 may have the same features as described above for the workpiece stack-up 24. For example, the workpiece stack-up 124 may include two or more metallic workpieces that are each formed of aluminum and/or steel.

The workpiece stack-up 124 has a first side 126 and a second side 128 and includes at least a first metal workpiece 130 and a second metal workpiece 132. In this example, the first metal workpiece 130 provides the first side 126 of the stack-up 124, and the second metal workpiece 132 provides the second side 128. Each of the first and second sides 126, 128 is accessible to a spot welding electrode 42, 44 such that the workpiece stack-up 124 can be clamped between the pair of opposed spot welding electrodes 42, 44 at a weld site WS. (The spot welding electrodes 42, 44 may be the same as described above). In some implementations, the workpiece stack-up 24 includes only the first and second metal workpieces 130, 132 (a “2T” stack-up). In other implementations, additional metal workpieces (not shown) may be positioned adjacent to one or both of the workpieces 130, 132 and form the outer sides 126, 128 of the stack-up 124. As described above, the workpieces 130, 132 may be formed of unalloyed aluminum, an aluminum alloy, or steel, by way of example, and may be coated.

The first and second workpieces 130, 132 each having faying surfaces 130′, 132′, respectively, that will be bonded together as described by resistance spot welding or brazing, as described above. Each faying surface 130′, 132′ has an interface portion 130″, 132″ at the weld site WS, wherein the interface portions 130″, 132″ are bonded together after the welding operation.

The first and second workpieces 130, 132 are disposed with the interface portions 130″, 132″ of the first workpiece faying surface 130″ and the second workpiece faying surface 132″ spaced apart a predetermined spacing distance E from each other. In the example of FIG. 5A, the first and second workpieces 130, 132 are spaced apart the distance E via an air gap 134 induced therebetween. The predetermined spacing distance E may be in the range of 0.25 to 2.5 millimeters, by way of example. In some variations, E may be in the range of 0.25 to 1.5 mm, 0.5 to 1.5 mm, 0.8 to 1.5 mm, or 0.75 to 1.25 mm. The predetermined spacing E need not be consistent through the entire volume of open space between the first and second faying surfaces 130′, 132′. Rather, the actual distance E between the first and second faying surfaces 130′, 132′ may vary throughout the volume of space within the air gap 34, so that the distance E may be, for example, 0.5 mm between the faying surfaces 130′, 132′ in one place and 0.6 mm between the faying surfaces 130′, 132′ in another place.

In this example, the air gap 134 or predetermined spacing distance E is created between the interface portions 130″, 132″ of each of the workpiece faying surfaces 130″, 132″ by one or more dimples or raised portions 135 and/or one or more folded-over portions 137. Either or both of the raised portions 135 and the folded-over portions 137 may be included. The raised portion 135 and/or the folded-over portion 137 of the second workpiece 132 contact the first workpiece 130. The second workpiece 132 has a gap bottom portion or valley bottom portion 139 disposed at the interface portion 132″ of the second workpiece faying surface 132′, where the valley bottom portion 139 is disposed away from the first workpiece 130 so that the air gap 134 is disposed between the valley portion bottom 139 and the first workpiece 130. The raised portion 135 may be created, for example, by stamping or otherwise forming a dimple in the workpiece 132. The folded-over portion 137 may be created, for example, by folding over an end 141 of the workpiece 132 onto itself.

FIG. 5B is a plan view with the first workpiece 130 removed to show details of the second workpiece 132 with the unitarily formed raised portion 135 and the folded-over portion 137. The raised portion 135 and/or folded-over portion 137 acts as a standoff to hold the interface portion 130″ of the first workpiece faying surface 130′ away from the interface portion 132″ of the second workpiece faying surface 132′ to form the air gap 134 between them and create the predetermined spacing distance E between the interface portions 130″, 132″ of the first and second faying surfaces 130′, 132′. Providing a space E between the workpieces 130, 132 causes the aluminum workpiece 130 to wrap around the weld face 64 of the electrode 42, and as a result, extend away from the adjacent workpiece 132. As such, a large notch root angle is formed upon welding, such as the notch root angle A shown in FIG. 4.

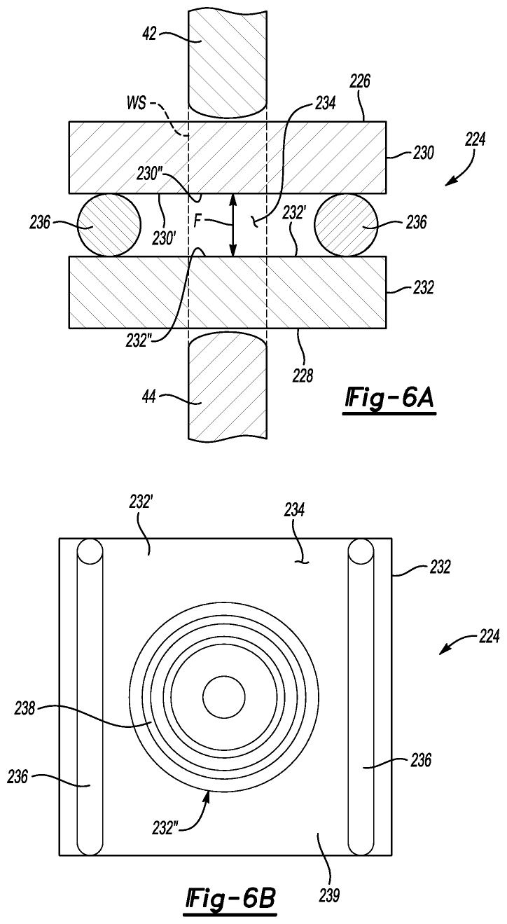

Referring now to FIGS. 6A-6B, another variation of the workpiece stack-up is illustrated and generally designated at 224. It should be understood that the workpiece stack-up 224 may be used in place of the workpiece stack-up 24 or 124, for example, on the body-in-white 10. Unless described as being different, the workpiece stack-up 224 may have the same features as described above for the workpiece stack-up 24 or 124. For example, the workpiece stack-up 224 may include two or more metallic workpieces that are each formed of aluminum and/or steel.

The workpiece stack-up 224 has a first side 226 and a second side 228 and includes at least a first metal workpiece 230 and a second metal workpiece 232. In this example, the first metal workpiece 230 provides the first side 226 of the stack-up 224, and the second metal workpiece 232 provides the second side 228 of the stack-up 224. Each of the first and second sides 226, 228 is accessible to a spot welding electrode 42, 44 such that the workpiece stack-up 224 can be clamped between the pair of opposed spot welding electrodes 42, 44 at a weld site WS. (The spot welding electrodes 42, 44 may be the same as described above). In some implementations, the workpiece stack-up 224 includes only the first and second metal workpieces 230, 232 (a “2T” stack-up). In other implementations, additional metal workpieces (not shown) may be positioned adjacent to one or both of the workpieces 230, 232 and form the outer sides 226, 228 of the stack-up 224. As described above, the workpieces 230, 232 may be formed of unalloyed aluminum, an aluminum alloy, or steel, by way of example, and may be coated.

The first and second workpieces 230, 232 each having faying surfaces 230′, 232′, respectively, that will be bonded together by resistance spot welding or brazing, as described above. Each faying surface 230′, 232′ has an interface portion 230″, 232″ at the weld site WS, wherein the interface portions 230″, 232″ of the faying surfaces 230′, 232′ are bonded together after the welding operation.

The first and second workpieces 230, 232 are disposed with the interface portions 230″, 232″ of the first and second workpiece faying surfaces 230′, 232′ spaced apart a predetermined spacing distance F from each other. In the example of FIG. 6A, the first and second workpieces 230, 232 are spaced apart the distance F via an air gap 234 induced therebetween. The predetermined spacing distance F may be in the range of 0.25 to 2.5 millimeters, by way of example. In some variations, F may be in the range of 0.25 to 1.5 mm, 0.5 to 1.5 mm, 0.8 to 1.5 mm, or 0.75 to 1.25 mm. The predetermined spacing F need not be consistent through the entire volume of open space between the first and second faying surfaces 230′, 232′. Rather, the actual distance F between the first and second faying surfaces 230′, 232′ may vary throughout the volume of space within the air gap 34, so that the distance F may be, for example, 0.5 mm between the faying surfaces 230′, 232′ in one place and 0.6 mm between the faying surfaces 230′, 232′ in another place.

In this example, the air gap 234 or predetermined spacing distance F is created between the interface portions 230″, 232″ of the workpiece faying surfaces 230′, 232′ by a shim material or object, such as one or more rods 236 disposed between the first and second workpieces 230, 232. The rods 236 contact both of the workpieces 230, 232 and serve to hold apart, or space apart, the interface portions 230″, 232″ of the faying surfaces 230′, 232′ from each other. Any desirable number of rods 236 may be included.

FIG. 6B is a plan view with the first workpiece 230 removed to show the rods 236 and the second workpiece 232. The rods 236 act as standoffs to hold the faying surface 230′ of the first workpiece 230 away from the faying surface 232′ of the second workpiece 232, to form the air gap 234 between them and create the predetermined spacing distance F between the first and second faying surfaces 230′, 232′. Providing a predetermined gap or space F between the workpieces 230, 232 causes the aluminum workpiece 230 to wrap around the weld face 64 of the electrode 42, and as a result, extend away from the adjacent workpiece 232. As such, a large notch root angle is formed upon welding, such as the notch root angle A shown in FIG. 4.

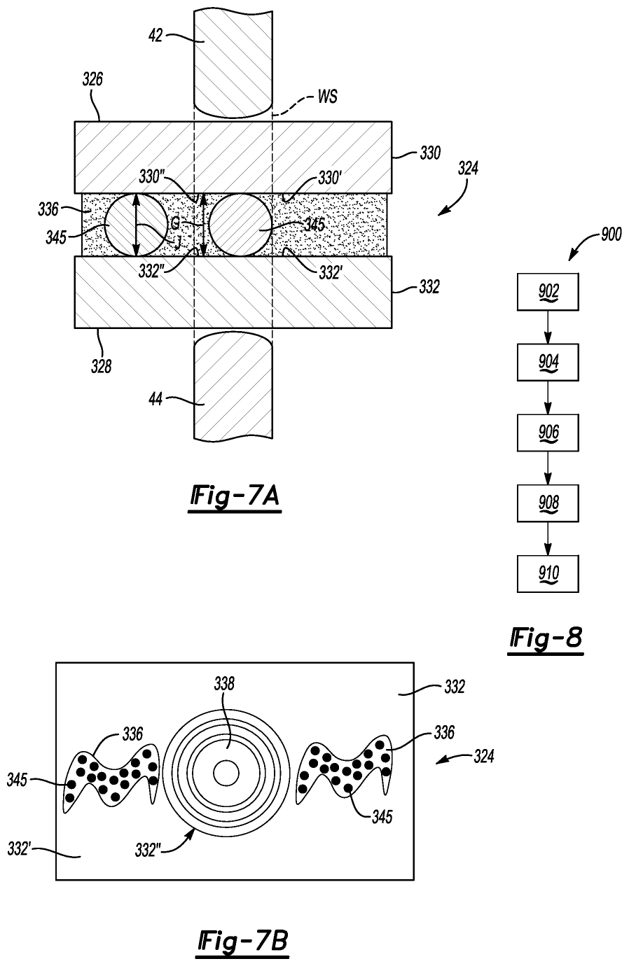

Referring now to FIGS. 7A-7B, another variation of the workpiece stack-up is illustrated and generally designated at 324. It should be understood that the workpiece stack-up 324 may be used in place of the workpiece stack-up 24, 124, or 224, for example, on the body-in-white 10. Unless described as being different, the workpiece stack-up 324 may have the same features as described above for the workpiece stack-up 24, 124, or 224. For example, the workpiece stack-up 324 may include two or more metallic workpieces that are each formed of aluminum and/or steel.

The workpiece stack-up 324 has a first side 326 and a second side 328 and includes at least a first metal workpiece 330 and a second metal workpiece 332. In this example, the first metal workpiece 330 provides the first side 326 of the stack-up 324, and the second metal workpiece 332 provides the second side 328 of the stack-up 324. Each of the first and second sides 326, 328 is accessible to a spot welding electrode 42, 44 such that the workpiece stack-up 324 can be clamped between the pair of opposed spot welding electrodes 42, 44 at a weld site WS. (The spot welding electrodes 42, 44 may be the same as described above). In some implementations, the workpiece stack-up 324 includes only the first and second metal workpieces 330, 332 (a “2T” stack-up). In other implementations, additional metal workpieces (not shown) may be positioned adjacent to one or both of the workpieces 330, 332 and form the outer sides 326, 328 of the stack-up 324. As described above, the workpieces 330, 332 may be formed of unalloyed aluminum, an aluminum alloy, or steel, by way of example, and may be coated.

The first and second workpieces 330, 332 each having faying surfaces 330′, 332′, respectively, that will be bonded together by resistance spot welding or brazing, as described above. Each faying surface 330′, 332′ has an interface portion 330″, 332″ at the weld site WS, wherein the interface portions 330″, 332″ of the faying surfaces 330′, 332′ are bonded together after the welding operation.

The first and second workpieces 330, 332 are disposed with the interface portions 330″, 332″ of the first and second workpiece faying surfaces 330′, 332′ spaced apart a predetermined spacing distance G from one another. In the example of FIG. 7A, the first and second workpieces 330, 332 are spaced apart the distance G with filler material 336 disposed between the first and second workpieces 336. The filler material 336 may fill in the entirety of the space between the workpieces 330, 332, or the filler material 336 may be disposed in part of the space between the workpieces 330, 332, while air or another standoff or shim may occupy the rest of the space between the workpieces 330, 332. The predetermined spacing distance G may be in the range of 0.25 to 2.5 millimeters, by way of example. In some variations, G may be in the range of 0.25 to 1.5 mm, 0.5 to 1.5 mm, 0.8 to 1.5 mm, or 0.75 to 1.25 mm. The predetermined spacing G need not be consistent through the entire volume of open space between the first and second faying surfaces 330′, 332′. Rather, the actual distance G between the first and second faying surfaces 330′, 332′ may vary throughout the volume of space within the air gap 34, so that the distance G may be, for example, 0.5 mm between the faying surfaces 330′, 332′ in one place and 0.6 mm between the faying surfaces 330′, 332′ in another place.

In this example, the predetermined spacing distance G is induced between the interface portions 330″, 332″ of the faying interfaces 330′, 332′ by the filler material 336, which may include particles 345, such as spheres or beads, disposed therein. The filler material 336 may be an adhesive or a sealing material, and the particles 345 may be a stronger material than the filler material 336, such as fibers or metallic or polymeric spheres. The filler material 336 may be conductive or non-conductive. The filler material 336 and/or the particles 345 disposed therein contacts both of the workpieces 330, 332 and serves to hold apart, or space apart, the faying surfaces 330′, 332′ from one another. In some example, the plurality of particles make up no more than 10% of the volume of the filler material.

FIG. 7B is a plan view with the first workpiece 330 removed to show the filler material 336 having bead particles 345 disposed therein and the second workpiece 332. The beads 345 may act as standoffs to hold the interface portion 330″ of the faying surface 330′ away from the interface portion 332″ of the faying surface 332′ to form the predetermined spacing G between the workpieces 330, 332. In some examples, the diameter J of the spheres 345 is equal, about equal, or substantially equal to the predetermined spacing distance G so that the spheres 345 can hold the workpieces 330, 332 at the predetermined spacing distance G from one another. Providing a predetermined space G between the workpieces 330, 332 causes the aluminum workpiece 330 to wrap around the weld face 64 of the electrode 42, and as a result, extend away from the adjacent workpiece 332. As such, a large notch root angle is formed upon welding, such as the notch root angle A shown in FIG. 4.

In some cases, each of the workpieces of the stack-up 24, 124, 224, 324 may be disposed with a slight sheet angle between the stack-up 24, 124, 224, 324 and the adjacent electrodes 42, 44, such as a sheet angle greater than 3 degrees due to poor fit-up between the workpieces of the stack-up. It has been discovered that quality welds could still be achieved by creating the predetermined space D, E, F, G between the workpieces, even when there was a sheet angle between poorly matched up workpieces.

Referring now to FIG. 8, a method of resistance spot welding a workpiece stack-up is provided and shown in a block diagram generally designated at 900. The method 900 utilizes the principles and procedures already described above. For example, the method 900 includes a step 902 of providing a first metallic workpiece having a first workpiece faying surface including an interface portion and a step 904 of providing a second metallic workpiece having a second workpiece faying surface including an interface portion. The method 900 further includes a step 906 of disposing the first and second metallic workpieces with the interface portions of the first and second workpiece faying surfaces spaced apart a predetermined spacing distance from each other. As such, a predetermined gap or spacing distance is induced between the workpieces in order to create a spot weld joint having a large notch angle, as described above, resulting in a higher quality weld.

The method 900 also includes a step 908 of providing a set of opposed welding electrodes including a first electrode and a second electrode, the first electrode being disposed on a side of the first workpiece, and the second electrode being disposed on a side of the second workpiece. The method 900 then includes a step 910 of applying pressure to the workpieces via the weld faces of the set of electrodes and heating the workpieces via the electrodes to form a spot weld joint between the interface portions of the first and second workpiece faying surfaces. Accordingly, the quality weld joint is formed.

The method 900 may include further optional steps in line with the description provided above, such as: providing the predetermined spacing distance in the range of 0.25 to 2.5 millimeters; forming the workpieces from aluminum and/or steel (or an aluminum alloy); spacing the faying interfaces of the workpieces apart via an air gap; disposing shim material between the first and second workpieces to space the first and second workpieces apart from one another; providing a cutout in the shim material to provide the air gap between the first and second faying surfaces; wherein the cutout is provided as being larger than an electrode face of the set of the electrodes; providing the shim material as being a polymeric material, at least one wire, at least one rod, and/or a plurality of beads; providing the second workpiece having a raised portion contacting the first workpiece; providing the second workpiece having a valley bottom portion disposed at the interface portion of the second workpiece faying surface, the valley bottom portion being disposed away from the first workpiece so that the air gap is disposed between the valley portion bottom and the first workpiece; providing the second workpiece as having a folded-over portion contacting the first workpiece and a gap bottom portion disposed away from the first workpiece so that the air gap is disposed between the gap bottom portion and the first workpiece; disposing a filler material between the first and second workpieces to create the predetermined spacing distance therebetween; the filler material comprising a plurality of particles disposed within the filler material, wherein each particle is adapted to space apart the interface portions of the first and second faying surfaces; providing the filler material as being at least one of an adhesive material and a sealing material; providing each particle having a height that is about equal to the predetermined spacing distance; providing the first workpiece and the first electrode with a sheet angle therebetween; the sheet angle being at least three degrees; wherein the step of heating the workpieces is accomplished by passing electrical current between the workpieces via the electrodes; and the welding step resulting in the spot weld joint having a notch root angle between the first and second workpieces, the notch root angle being at least 30 degrees.

The detailed description and the drawings or figures are supportive and descriptive of the many aspects of the present disclosure. The elements described herein may be combined or swapped between the various examples. For example, except where described as being different, the details described with respect to FIGS. 1-7B may be applied to the method schematically shown in FIG. 8. While certain aspects have been described in detail, various alternative aspects exist for practicing the invention as defined in the appended claims. The present disclosure is exemplary only, and the invention is defined solely by the appended claims.

What is claimed is:

1. A method of resistance spot welding a workpiece stack-up, the method comprising:
providing a first metallic workpiece having a first workpiece faying surface including an interface portion;
providing a second metallic workpiece having a second workpiece faying surface including an interface portion;
disposing the first and second metallic workpieces with the interface portions of the first and second workpiece faying surfaces spaced apart a predetermined spacing distance from each other, the predetermined spacing distance being in the range of 0.25 to 2.5 millimeters;
providing a set of opposed welding electrodes including a first electrode and a second electrode, the first electrode being disposed on a side of the first workpiece, and the second electrode being disposed on a side of the second workpiece;
applying pressure to the workpieces via the weld faces of the set of electrodes and heating the workpieces via the electrodes to form a spot weld joint between the interface portions of the first and second workpiece faying surfaces.

2. The method of claim 1, wherein the second workpiece is formed of a steel alloy and the first workpiece is formed of one of aluminum and an aluminum alloy.

3. The method of claim 1, wherein each of the first and second workpieces is formed of one of aluminum and an aluminum alloy.

4. The method of claim 1, the interface portions of the first workpiece faying surface and the second workpiece faying surface being spaced apart from one another via an air gap.

5. The method of claim 4, further comprising disposing shim material between the first and second workpieces to space the first and second workpieces apart from one another.

6. The method of claim 5, further comprising providing a cutout in the shim material to provide the air gap between the first and second faying interfaces, wherein the cutout is provided as being larger than a weld face of each electrode.

7. The method of claim 5, further comprising providing the shim material as at least one of the following: a polymeric material, a glass material, a ceramic material, at least one wire, at least one rod, and a plurality of beads.

8. The method of claim 4, further comprising providing the second workpiece having a raised portion contacting the first workpiece and providing the second workpiece having a valley bottom portion disposed at the interface portion of the second workpiece faying surface, the valley bottom portion being disposed away from the first workpiece so that the air gap is disposed between the valley portion bottom and the first workpiece.

9. The method of claim 4, further comprising providing the second workpiece as having a folded-over portion contacting the first workpiece and a gap bottom portion disposed away from the first workpiece so that the air gap is disposed between the gap bottom portion and the first workpiece.

10. The method of claim 1, further comprising disposing a filler material between the first and second workpieces to create the predetermined spacing distance therebetween, the filler material comprising a plurality of particles disposed within the filler material, the plurality of particles being adapted to space apart the interface portions of the first and second faying surfaces, the plurality of particles being no more than 10% of a volume of the filler material.

11. The method of claim 10, further comprising providing the filler material as being at least one of an adhesive material and a sealing material.

12. The method of claim 10, further comprising providing each particle having a height that is about equal to the predetermined spacing distance.

13. The method of claim 1, further comprising providing the first workpiece and the first electrode with a sheet angle therebetween, the sheet angle being at least three degrees.

14. The method of claim 1, wherein the step of heating the workpieces is accomplished by passing electrical current between the workpieces via the electrodes.

15. The method of claim 14, resulting in the spot weld joint having a notch root angle between the first and second workpieces, the notch root angle being at least 25 degrees.

16. The method of claim 1, the predetermined spacing distance being in the range of 0.8 to 1.5 millimeters.

17. A spot-welded workpiece assembly comprising:
a metallic first workpiece;
a metallic second workpiece spot welded to the first workpiece by a spot weld joint, the first and second workpieces having a notch root angle therebetween at an edge of the spot weld joint, the notch root angle being at least 25 degrees; and
a gap-inducing element disposed between the first and second workpieces and configured to space apart the faying surfaces of the first and second workpieces by a predetermined distance prior to spot welding the first and second workpieces together.

18. The spot-welded workpiece assembly of claim 17, the first workpiece being formed of one of aluminum and an aluminum alloy, and the second workpiece being formed of one of the following: aluminum, an aluminum alloy, and a steel alloy.

19. The spot-welded workpiece assembly of claim 18, wherein the gap-inducing element is a shim having portions forming a cutout therethrough, the spot weld joint extending through the cutout.

20. The spot-welded workpiece assembly of claim 18, the gap-inducing element including at least one of: a raised portion formed in one of the first and second workpieces, a folded-over portion of one of the first and second workpieces, and a filler material having a plurality of gap-inducing particles disposed therein.
